(19) United States
(12) Patent Application Publication
(10) Pub. No.: US 2006/0007710 A1
(43) Pub. Date: Jan. 12, 2006

(54) Method of manufacturing decorative string light

(76) Inventor: Shih-Ming Huang, Hsinchu City (TW)

Correspondence Address: SUPREME PATENT SERVICES, POST OFFICE BOX 2339, SARATOGA, CA, 95070, US

(21) Appl. No.: 10/889,236

(22) Filed: Jul. 10, 2004

(51) Int. Cl. H01R 33/00

(52) U.S. Cl. 362/653

(57) ABSTRACT

A method of manufacturing light bulbs for us in decorative string light is provided. The manufactured glass light bulbs have a shielding layer at their bottom. The two metal conductive pins of the light bulb extend beyond the shielding layer. The manufacturing method includes using an inject molding method to form a monolithic shield layer at the bottom of the light bulb. The shape of the shield layer is manufactured to match the shape of the bulb cap used in the string light. The method provides a light bulb whose structure is easy for assembly, inexpensive and easy to manufacture, and safe in use.

### FIELD OF THE INVENTION

The present invention generally relates to a method of manufacturing decorative string light, and more specifically to an inject molding method to directly form a shielding layer at the bottom of the light bulbs.

### BACKGROUND OF THE INVENTION

FIG. 1 shows an exploded view of a conventional decorative string light structure, including a tungsten filament (generally known as soft filament) bulb 11, a softhead 12, a bulb cap 13, and a pair of metal conductive stripes 14, assembled in the following manner: plugging bulb 11 into softhead 12 so that the two metal pins 111 of bulb 11 extend beyond softhead 12, conductive stripe 14 of conductive wire 15 housed inside the bottom of bulb cap 13, and finally plugging softhead 12 into bulb cap 13 so that metal pins 111 are in contact with conductive strips 14 to form electrical connection. The most difficult part during the assembly is metal pins 111 must be inserted into the small holes (now shown) of bulb cap 12 when bulb 11 is inserted into cap 12 so that metal pins 111 can extend beyond bulb cap 12. This step is not only difficult but also prone to errors; hence, increases the manufacturing cost In addition, to prevent bulb 11 from turning to cause the break or short circuit of metal pins 111, some manufacturers would add the adhesive glue between bulb 11 and bulb cap 12 to prevent turning as well as increase the fixture. But this further complicates the manufacture process. It is imperative to devise a new manufacturing method to achieve the goal with less manufacturing cost.

### SUMMARY OF THE INVENTION

The primary goal of the present invention is to provide a decorative string light manufacturing method that is easy to manufacture, safe to use, and low in cost. The method includes forming a monolithic shielding layer at the bottom of the bulb. The shape of the shielding layer resembles the softhead of the conventional structure. Therefore, the finished product can be directly plugged into the conventional bulb cap to form a complete string light. This not only simplifies the assembly process, but also prevents the turning of the bulbs as in the conventional structure; thus the safety of use is improved.

To achieve the aforementioned goal, the present invention is to add a step of inject molding to the end of the manufacturing process. That is, after the bulbs are formed, a mold is used to form an inject molding shielding layer at the bottom of the bulbs. The shape of the shielding layer depends on the shape of the bulb cap so that it is more convenient to assemble and safe to use.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows an exploded view of a structure of a conventional decorative string light;

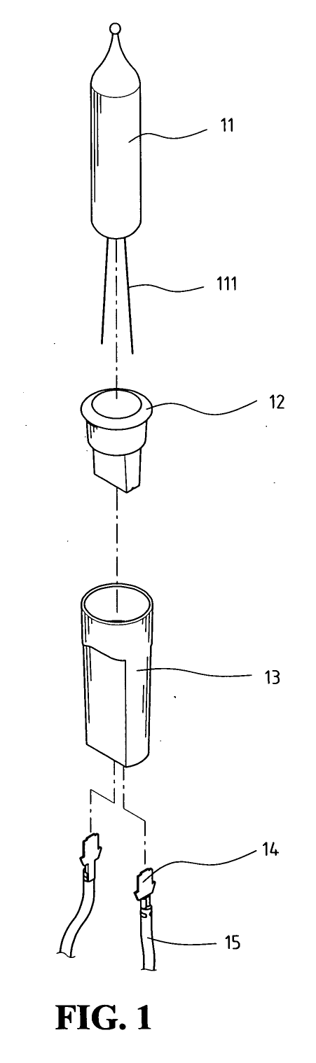

FIG. 2 shows a flowchart of the manufacturing method of the present invention;

FIG. 3 shows a 3-dimensional view of the present invention;

FIG. 4 shows a cross-sectional view of the present invention;

FIG. 5 shows a second embodiment of the present invention with matched bulb cap and metal conductive stripe;

FIG. 6 shows a third embodiment of the present invention with matched bulb cap and metal conductive stripe; and

FIG. 7 shows a fourth embodiment of the present invention with matched bulb cap and metal conductive stripe.

### DETAILED DESCRIPTION OF THE PREFERRED EMBODIMENTS

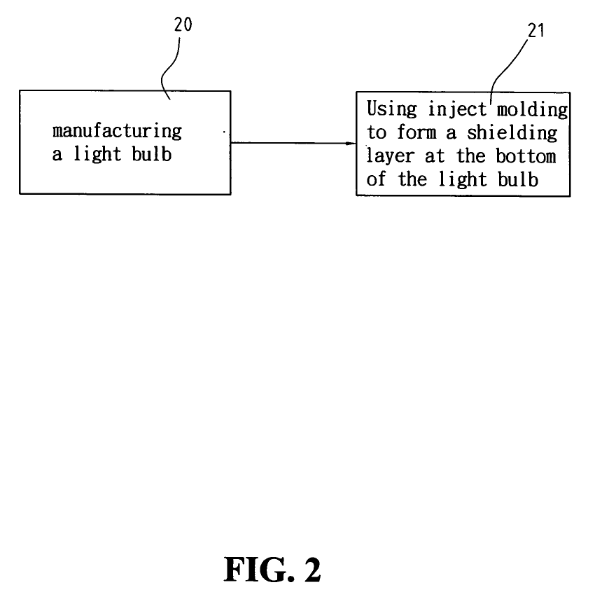

FIG. 2 shows a flowchart of the present invention, including two steps. Step 20 is to manufacture a light bulb. The finished light bulb includes two metal pins at the bottom. Inside the sealed light bulb is a tungsten filament which will illuminate when in use. Step 21 is to form a shielding layer using an inject molding method. The shape of the shielding layer can be manufactured to match the shape of the bulb cap. The entire manufacturing process is complete in sequence; that is, the shielding layer is manufactured directly after the light bulb is manufactured. Therefore, the finished product of the present invention is a light bulb with a monolithic shielding layer at the bottom.

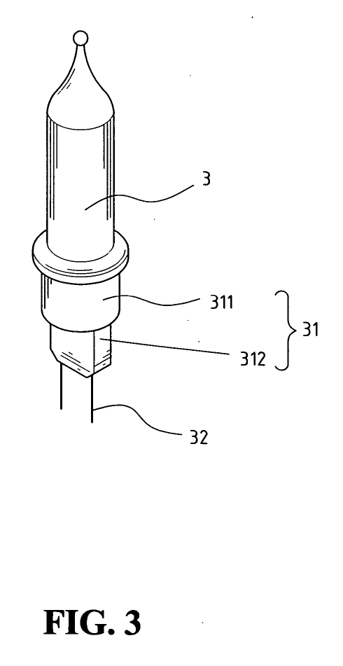

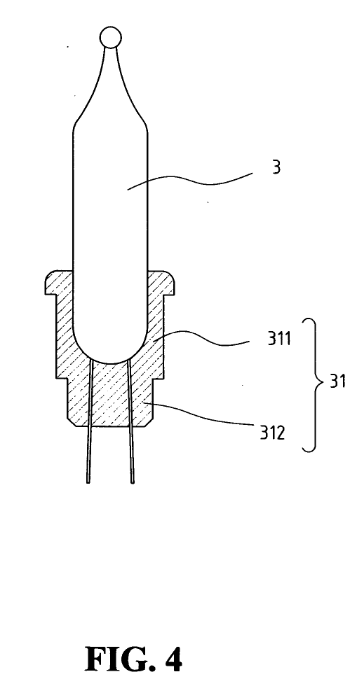

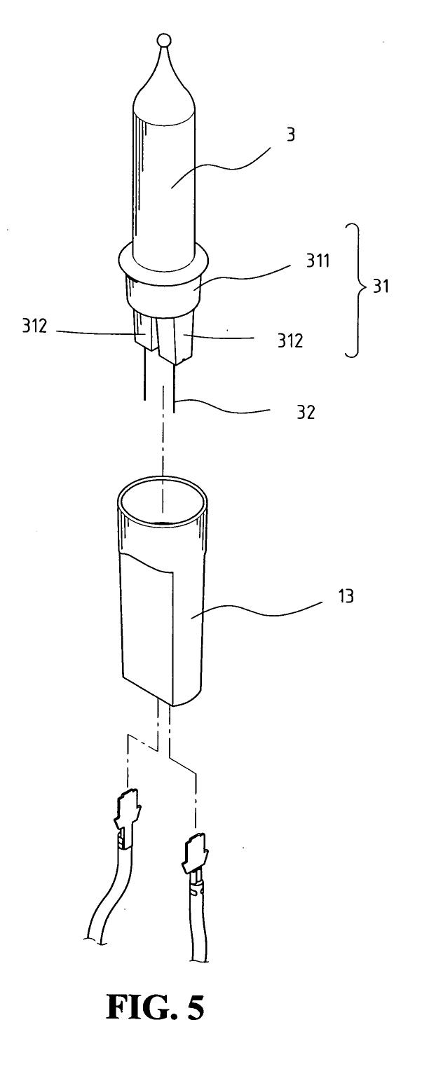

FIG. 3 and FIG. 4 show the three-dimensional and cross-sectional views of a light bulb manufactured in accordance with the method of the present invention. The light bulbs can be used in string lights for Christmas or ceremonial decoration. The main body of a light bulb 3 is made of a glass with low power tungsten filament bulb having a shape of long stripe, as shown in the figures. At the bottom of bulb 3 is a monolithic shielding layer 31, made of insulation material, such as plastic. The shape of shielding layer 31 is to match the interior shape of the bulb cap. In this embodiment, shielding layer 31 includes a cone 311 at the upper part and a strut 312 at the lower part so that the finished bulb 3 can be directly plugged into a bulb cap of a conventional string light. FIG. 5 shows another embodiment of the present invention. In this embodiment, a light bulb 3 includes a shielding layer 31 at the bottom. Shielding layer 321 includes two independent struts 312 at the lower part to cover two metal pins 32 of bulb 31, respectively. In other words, shield layer 31 can be manufactured to match the shape of bulb cap 13.

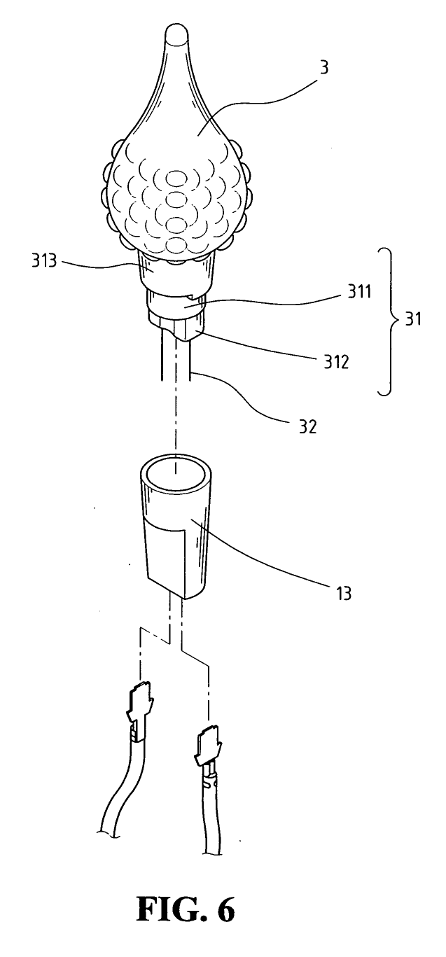

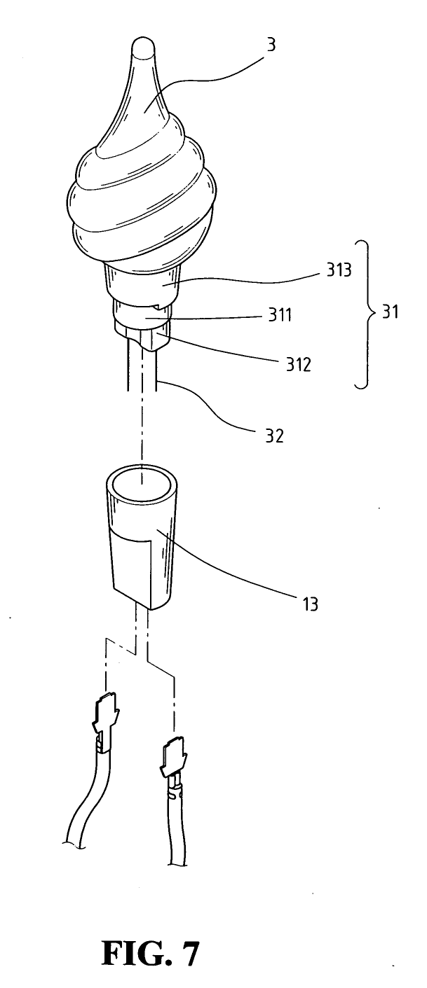

FIG. 6 and FIG. 7 show the third and the fourth embodiments of the present invention. The light bulbs of both embodiments are tungsten filament bulbs, but are large in size and may have different shape. The bulb in FIG. 6 has a shape of a grape, and the bulb in FIG. 7 has a shape of a screw. Both bulbs have a shielding layer 31 at the bottom. The top of shielding layer 31 includes a large-size shield part 313, which is made to match the large size of light bulb 3 so that the assembly of the two would be easier. In other words, the shape of the light bulbs of the present invention can be either long stripe, cone, or any other shape, and the shape of the shielding layer cal also be manufactured to match the bulb cap.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of manufacturing decorative string light, comprising:
providing a glass light bulb; and
using inject molding to directly form a shielding layer at said light bulb, said shield layer being made of insulator.

2. The method as claimed in claim 1, wherein said light bulb is a glass tungsten filament light bulb of any shape.

3. The method as claimed in claim 1, wherein the shape and the size of said shielding layer of said light bulb are manufactured to match the bulb cap of a string light to be used.

4. The method as claimed in claim 1, wherein said insulator for shielding layer is plastic.

5. The method as claimed in claim 1, wherein said shielding layer is shaped as a cone at upper part and a long strut at lower part, and said bulb has two metal pins extending beyond the ends of said strut.

6. The method as claimed in claim 4, wherein said lower strut of said bulb further comprises two independent parts.

7. The method as claimed in claim 1, wherein said shielding layer further comprises a large-size shield part for using with large-size light bulbs.

8. A structure of a light bulb used in decorative string light, comprising:
a light bulb; and
a shielding layer, said shielding layer being located at the bottom of said light bulb and manufactured by inject molding directly on said light bulb; said light bulb having two metal pins extending beyond said shielding layer.
